(19) United States
(12) Patent Application Publication
(10) Pub. No.: US 2025/0077217 A1
(43) Pub. Date: Mar. 6, 2025

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Akihiro YAMAGUCHI, Kita Tokyo (JP); Ken UENO, Tachikawa Tokyo (JP); Ryusei SHINGAKI, Setagaya Tokyo (JP)

(21) Appl. No.: 18/734,479

(22) Filed: Jun. 5, 2024

(30) Foreign Application Priority Data
Sep. 5, 2023 (JP) 2023-143639

(51) Int. Cl. G06F 8/65; G06F 11/34

(52) U.S. Cl. CPC G06F 8/65; G06F 11/3409

(57) ABSTRACT

An information processing device according to one embodiment includes one or more hardware processors. The hardware processors executes update processing on a designated number of first sections on the basis of a first estimation result and a second estimation result. The first estimation result is obtained by inputting first time-series data to an estimation model. The second estimation result is obtained by inputting second time-series data to the estimation model. The second time-series data is obtained by applying mask processing to partial time-series data of a second section in the first time-series data. The second section is other than the designated number of the first sections.

### CROSS-REFERENCE TO RELATED APPLICATIONS

This application is based upon and claims the benefit of priority from Japanese Patent Application No. 2023-143639, filed on Sep. 5, 2023; the entire contents of which are incorporated herein by reference.

### FIELD

Embodiments described herein relate generally to an information processing device, an information processing method, and a computer program product.

### BACKGROUND

There is an increasing need for an analysis technology of analyzing (diagnosing) time-series data (time-series waveform data) by machine learning.

The analysis includes processing to estimate (detect, predict, etc.) whether the time-series data is in a specific state (for example, being normal or abnormal) (such as abnormal waveform detection), processing to classify the time-series data into classes (time-series classification), and the like. In such a technology, in addition to improvement of analysis performance, improvement of explanatory property of clearly presenting a basis of analysis is desired.

Meanwhile, in fields such as unsupervised abnormal waveform detection and time-series classification, a black box technology having no explanatory property is mainly used as a high-performance waveform analysis method. Therefore, a technology of giving the explanatory property to a model learned by a black box analysis technology has been proposed. For example, a technology using a saliency map that highlights a portion contributing to prediction (a portion serving as a basis of analysis) in time-series data to be analyzed has been proposed.

However, in the related art, there is a case where it is not possible to appropriately obtain a portion serving as a basis of analysis. For example, in the related art, there is a case where it is not clear how many portions serving as the basis are extracted.

In addition, depending on data and parameter setting, there is a possibility that a portion serving as a basis is found as a large number of small pieces of sections.

### BRIEF DESCRIPTION OF THE DRAWINGS

FIG. 1 is a view for describing a function of an embodiment;

FIG. 2 is a block diagram of an information processing device of a first embodiment;

FIG. 3 is a flowchart of estimation processing in the first embodiment;

FIG. 4 is a view illustrating an example of a display screen that displays a processing result;

FIG. 5 is a block diagram of a configuration of an information processing device of a second embodiment;

FIG. 6 is a flowchart illustrating an example of estimation processing in the second embodiment;

FIG. 7 is a view illustrating an example of a display screen of the second embodiment; and

FIG. 8 is a hardware configuration diagram of the information processing device of the first or second embodiment.

### DETAILED DESCRIPTION

An information processing device according to one embodiment includes one or more hardware processors. The one or more hardware processor are configured to execute update processing on a designated number of first sections on the basis of a first estimation result and a second estimation result. The first estimation result is obtained by inputting first time-series data to an estimation model. The second estimation result is obtained by inputting second time-series data to the estimation model. The second time-series data is obtained by applying mask processing to partial time-series data of a second section in the first time-series data. The second section is other than the designated number of the first sections.

In the following, preferable embodiments of an information processing device according to the present disclosure will be described in detail with reference to the accompanying drawings.

Similarly to learning of a model used for analysis, a portion to be a basis of the analysis of time-series data is obtained by updating parameters in such a manner as to optimize an objective function. Therefore, processing to obtain the portion serving as the basis may be referred to as learning, and parameters to be updated in this processing may be referred to as learning parameters.

As described above, in the related art, there is a case where it is not possible to appropriately obtain a portion to be a basis of analysis of time-series data. For example, a technology in which importance of each point on time-series data is used as a learning parameter, a prediction error and the importance of each point are reduced at the time of learning, and points having high importance are adjusted to be merged into a sub-sequence (section including a plurality of points) by utilization of a technique called Fused Lasso (Least Absolute Shrinkage and Selection Operator) has been proposed. Fused Lasso is a technique using a regularization term in which adjacent parameters have similar values. However, in such a technology, it is not possible to adjust how many sub-sequences are generated. Therefore, for example, a large number of very short sub-sequences may be generated. Moreover, in such a technology, the number of learning parameters increases in a linear order of a time-series length.

Therefore, in the following embodiments, it is made possible to designate the number of sections SA (first sections) corresponding to portions serving as a bases for analysis of time-series data, and the designated number of sections SA are obtained as bases for the analysis. Since the number of sections can be designated, for example, it is possible to avoid a situation in which a large number of short sections are generated, and to more appropriately obtain a portion to be a basis of analysis. In addition, since increasing in a linear order of the number of sections including a plurality of points, the number of learning parameters can be reduced as compared with the above-described technology using each point as a learning parameter.

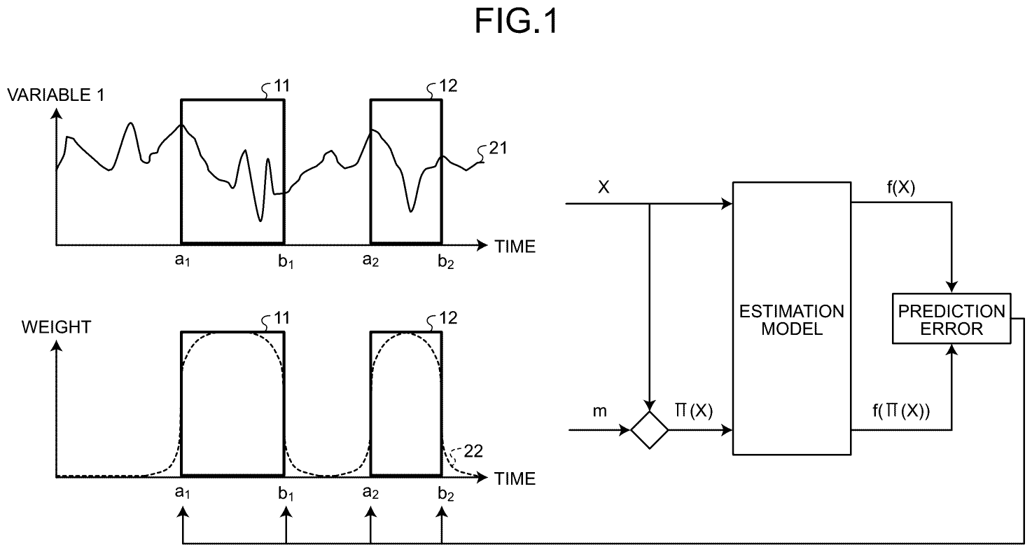

First, functions common to the following embodiments (first embodiment and second embodiment) will be described. FIG. 1 is a view for describing common functions.

An estimation model f in FIG. 1 is a model that inputs time-series data X (first time-series data) and outputs f(X) that is an estimation result (first estimation result). The estimation model f corresponds to a black box model that does not output a basis of estimation of the estimation result. In addition, the estimation model f inputs time-series data Π(X) (second time-series data) obtained by application of mask processing to partial time-series data of a section SB (second section) other than the designated number of sections SA in the time-series data X, and outputs f(Π(X)) that is an estimation result (second estimation result).

In the related art, each point of the time-series data is learned as a learning parameter. On the other hand, in the embodiments, first, the number of sections SA to be obtained (hereinafter, referred to as a number K) is designated. An example in which 2 is designated as K is illustrated in FIG. 1. Then, for the k-th (k is an integer satisfying 1≤k≤K) section SA, a parameter that defines the section SA is learned as a learning parameter.

The parameter defining the section SA may be any parameter, and for example, the following parameters can be used.
A parameter indicating positions of two end points (left end point aₖ and right end point bₖ) on the time-series data.
A parameter indicating a position of one end point (left end point aₖ or right end point bₖ) on the time-series data, and a parameter indicating a length of a section.

Hereinafter, a case where the section SA is defined by the left end point aₖ and the right end point bₖ will be described as an example. In FIG. 1, a section 11 defined by a left end point a₁ and a right end point b₁ and a section 12 defined by a left end point a₂ and a right end point b₂ are illustrated as examples of the section SA.

A gradient descent method may be used for learning of the learning parameter. In order to make it possible to apply the gradient descent method, both end points (left end point aₖ and right end point bₖ) of the section SA are smoothly defined (defined in a differentiable manner). A method of smoothly defining an end point may be any method, and a method of performing defining by using a sigmoid function can be applied, for example.

Time-series data X to be processed is D-variate time-series data including D (D is an integer of 1 or more) variables. An example in which univariate time-series data 21 having one variable (D=1) is set as the time-series data X is illustrated in FIG. 1.

Note that a graph 22 in FIG. 1 represents weight of the section SA of a case of a configuration in which the weight of the section SA is also updated as a parameter (details will be described later). Hereinafter, the weight of the section SA is referred to as section weight. The section weight can also be interpreted as an index representing importance of the section SA.

In the present embodiment, the section SA (both end points) is learned in such a manner that a difference (prediction error) between an estimation result f(X) of the estimation model f for the time-series data X and an estimation result f(Π(X)) of the estimation model f for the time-series data Π(X) to which the mask processing is applied is minimized. In other words, the section SA is learned in such a manner that the estimation result does not change even when the time-series data of the section SB other than the section SA is ignored.

In a case where pieces of sensor data are monitored, the time-series data X to be processed is multivariate time-series data (D is 2 or more). In a case where the multivariate time-series data is a target, there are the following two methods as methods of designating the number of sections SA.
(M1) The number of sections SA is individually designated for each variable.
(M2) A value being common to the D variables is designated as the number of sections SA.

Here, outlines of the two methods will be described. Details are described in each of the following embodiments. In (M1), for example, a user can finely designate the number of sections SA for each variable (such as each sensor). In (M1), the method for the univariate time-series data described in FIG. 1 may be independently applied to each of the variables.

In (M2), for example, the user designates a value that is common to all variables (such as sensors) as the number of sections SA. Such a method is effective in a case where it is unknown which variable contributes to prediction. In (M2), while each section SA is learned with all the variables being combined into one, weight indicating which variable is valid is simultaneously learned for each section SA.

Either one of the above two methods may be used, or may be used in combination. In a case of the combination, the methods may be executed in the following procedure.
First, the sections SA over all variables are obtained by (M2).
While confirming the obtained sections SA, the user determines and designates, for each of the variables, the number of sections SA and a ratio of the section SA to the time-series data length. Then, (M1) is executed in accordance with the designation.

Hereinafter, embodiments corresponding to the above two methods will be described. The above-described (M1) and (M2) correspond to the first embodiment and the second embodiment, respectively.

### First Embodiment

An information processing device of the first embodiment is configured to learn sections SA whose number is designated for each of D variables of D-variate time-series data.

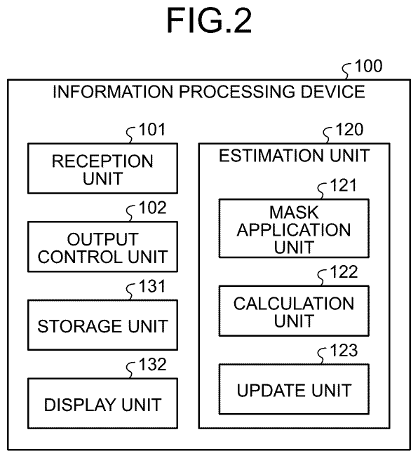

FIG. 2 is a block diagram illustrating an example of a configuration of an information processing device 100 of the first embodiment. As illustrated in FIG. 2, the information processing device 100 includes a reception unit 101, an estimation unit 120, an output control unit 102, a storage unit 131, and a display unit 132.

The reception unit 101 receives an input of various kinds of information used in the information processing device 100. For example, the reception unit 101 receives a learned estimation model f, time-series data X to be estimated, and designation of the number of sections SA by the user or the like.

The estimation model f may be a model constructed (learned) by any method as long as being a model that outputs an estimation result in response to an input of the time-series data X. For example, the estimation model f is a model that performs detection of unsupervised abnormal waveform, or a model that performs time-series classification.

In a case of the model that performs the unsupervised abnormal waveform detection, the estimation model f outputs, for example, an abnormality score or a normality score as an estimation result. The estimation model f may be a model implemented by the following technology by utilization of an unsupervised waveform feature generated by utilization of Minirocket.
Deep Support Vector Data Description (DeepSVDD)
Empirical-Cumulative-distribution-based Outlier Detection (ECOD)

In a case of the model that performs the time-series classification, the estimation model f outputs estimation results, each indicating probability of belonging to each of classes, which may be calculated by a softmax function.

The estimation unit 120 estimates (learns), by using the estimation model f, a section SA corresponding to a portion that is a basis of the estimation result for the time-series data X. The estimation unit 120 includes a mask application unit 121, a calculation unit 122, and an update unit 123.

The mask application unit 121 applies mask processing to partial time-series data in the section SB that is other than the section SA in the time-series data X. In one example, the mask application unit 121 applies the mask processing in such a manner that an application rate of the mask processing increases from an end point of the section SA toward the outside of the section SA and the application rate decreases toward the inside of the section SA.

The calculation unit 122 calculates a difference (prediction error) between the estimation result f(X) of the estimation model f of when the time-series data X is input and the estimation result f(Π(X)) of the estimation model f of when the time-series data Π(X) to which the mask processing is applied by the mask application unit 121 is input.

The update unit 123 executes update processing to update designated K sections SA in such a manner as to optimize an objective function including the difference calculated by the calculation unit 122. The update of the sections SA corresponds to updating the parameters (positions of the left end point aₖ and the right end point bₖ) defining the sections SA. Any method may be applied to the processing of updating the parameter, and the gradient descent method can be applied, for example. Details of the objective function used for the update processing will be described later.

The output control unit 102 controls an output of various kinds of information used in the information processing device 100. For example, the output control unit 102 outputs (displays or visualizes) the K sections SA, which are a result of the update processing, to the display unit 132.

At least part of the units (reception unit 101, estimation unit 120, and output control unit 102) may be implemented by one or more processing units. In one example, the above units are implemented by one or more hardware processors. The above units may be implemented by processors such as a central processing unit (CPU) and a graphics processing unit (GPU) caused to execute computer programs, namely, implemented by software. The above units may be implemented by a processor such as a dedicated integrated circuit (IC), namely, implemented by hardware. The above units may be implemented by utilization of software and hardware in combination. In a case where two or more processors are used, each processor may implement one of the units or some of the units.

The storage unit 131 stores various kinds of information used in the information processing device 100. For example, the storage unit 131 stores information indicating the learned estimation model f, the time-series data X, and the like.

Note that the storage unit 131 can include any kind of generally-used storage medium such as a flash memory, a memory card, a random access memory (RAM), a hard disk drive (HDD), and an optical disk.

The display unit 132 is an example of a device that outputs the various kinds of information used in the information processing device 100. The display unit 132 is implemented by, for example, a display device such as a liquid crystal display.

Note that the information processing device 100 may be physically configured by one device or may be physically configured by multiple devices. For example, the information processing device 100 may be provided on a cloud environment. Moreover, each unit in the information processing device 100 may be dispersedly provided in multiple devices.

Next, various kinds of data used in estimation processing by the information processing device 100 of the first embodiment will be described. The estimation processing is processing of estimating (learning) a portion (positions of both end points of the section SA) serving as a basis of the estimation result for the estimation result of the time-series data X by the learned estimation model f.

Hereinafter, the number of variables is D, and an index of the variables is d (d is an integer satisfying 1≤d≤D). The d-th variable may be referred to as a variable d. The number of sections SA in the variable d is denoted by K_{d}, and an index of the sections SA is denoted by k (k is an integer satisfying 1≤k≤K_{d}). That is, positions of the left end points a_{k, d} and the right end points b_{k, d} of the sections SA are described as A and B collectively for all K₁+K₂+ . . . . K_{D} positions. A and B are generally represented as direct products of K_{d}-dimensional continuous value vectors over d=1, 2, . . . , D, and are briefly represented as a K x D continuous value matrix, specifically when K=K₁=K₂= . . . =K_{D}.

Here, the time series data X is univariate time-series data in a case of D=1, and the time-series data X is multivariate time-series data in a case where D is a number of two or more. Note that in a case where the section weight of each of the sections SA is considered, the section weight v_{k, d} is described as V collectively for all the K₁+K₂+ . . . . K_{D} pieces of section weight. V is generally expressed as a direct product of the K_{d}-dimensional continuous value vectors over d=1, 2, . . . , D, and is briefly expressed as a K× D continuous value matrix specifically when K=K₁=K₂= . . . =K_{D}.

For example, a position of a left end point, a position of a right end point, and section weight of the k-th section SA in the d-th variable are respectively described as a_{k, d}, b_{k, d}, and v_{k, d}. Note that the section weight V is determined in such a manner as to satisfy the following condition (C1), for example.

$$With k = 1 , 2 , … , and K and d = 1 , 2 , … , \\ and D , {v}_{k , d} \geq 0 and {v}_{1 , d} + {v}_{2 , d} + … + {v}_{k , d} = 1 \qquad ( C1 )$$

Next, an example of the objective function will be described. The following expression (1) is an example of the objective function used by the update unit 123.

$${minimize}_{A ∈ {ℝ}^{K \times D} , B ∈ {ℝ}^{K \times D}} ℒ ( f ( X ) , ( f ∘ \prod ) ( X ) ) + λ {\sum }_{d = 1}^{D} {\sum }_{k = 1}^{K} ( {b}_{k , d} - {a}_{k , d} ) \qquad ( 1 )$$

In the expression (1), minimize indicates minimization (example of optimization) of the objective function described on the right side. A and B are respectively collective notations of the left end points a_{k, d} and the right end points b_{k, d} across k=1, 2, . . . , and K and d=1, 2, . . . , and D. An error function L (x, y) is a function of calculating a difference between x and y.

The first term of the objective function in the expression (1) corresponds to an error function L representing a difference (prediction error) between the estimation result f(X) of the estimation model f for the time-series data X and the estimation result f(Π(X)) of the estimation model f for the time-series data Π(X) to which the mask processing is applied. The second term of the objective function corresponds to a regularization term in which a value becomes smaller as the length of the section SA becomes shorter. λ is a non-negative hyperparameter.

Π(X) corresponding to the mask processing is expressed by the following expression (2). The right side of the expression (2) is expressed by the following expression (3). In addition, m( ) in the expression (3) is expressed by the following expression (4).

$${[ \prod ( X ) ]}_{d , t} := π ( t , {x}_{d} , {μ}_{d} , {a}_{k , d} , {b}_{k , d} ) \qquad ( 2 )$$

$$π ( t , {x}_{d} , {μ}_{d} , {a}_{k , d} , {b}_{k , d} ) := m ( t , {a}_{k , d} , {b}_{k , d} ) {x}_{d , t} + ( 1 - m ( t , {a}_{k , d} , {b}_{k , d} ) ) {μ}_{d , t} \qquad ( 3 )$$

$$m ( t , {a}_{k , d} , {b}_{k , d} ) := min ( σ ( t - {a}_{k , d} ) , 1 - σ ( t - {b}_{k , d} ) ) \qquad ( 4 )$$

t represents time. x_{d} represents time-series data of the variable d included in the time-series data X. μ_{d} represents time-series data corresponding to a mask obtained in advance. A coefficient (1−m(t, a_{k, d}, b_{k, d})) by which μ_{d} is multiplied corresponds to an application rate of the mask processing. σ( ) in the expression (4) corresponds to a sigmoid function expressed by the following expression (5). β represents a temperature parameter of the sigmoid function.

$$σ ( v ) := {( 1 + {e}^{- β v} )}^{- 1} \qquad ( 5 )$$

The objective function may include a term in which the application rate of the mask processing changes with the section weight V (first weight) including K×D pieces of section weight v_{k, d} respectively corresponding to the sections SA. In one example, a larger application rate is set for the section SA having the smaller section weight v_{k, d}. In this case, the update unit 123 updates the sections SA and the section weight V in such a manner as to minimize the objective function.

The following expression (6) expresses an example of the objective function including a term related to the section weight. V is a collective notation of the pieces of section weight v_{k, d} across k=1, 2, . . . , and K and d=1, 2, . . . , and D.

$${minimize}_{A ∈ {ℝ}^{K \times D} , B ∈ {ℝ}^{K \times D} , V ∈ {ℝ}^{K \times D}} ℒ ( f ( X ) , ( f ∘ \prod ) ( X ) ) + λ {\sum }_{d = 1}^{D} {\sum }_{k = 1}^{K} ( {b}_{k , d} - {a}_{k , d} ) \qquad ( 6 )$$

The following expression (7) expresses an example of Π(X) used in the expression (6). The right side of the expression (7) is expressed by the following expression (8). In addition, m ( ) in the expression (8) is expressed by the following expression (9). v˜ (variable with a tilde symbol “˜” above v) in the expression (9) is expressed by the following expression (10).

$${[ \prod ( X ) ]}_{d , t} := π ( t , {x}_{d} , {μ}_{d} , {a}_{k , d} , {b}_{k , d} , V ) \qquad ( 7 )$$

$$π ( t , {x}_{d} , {μ}_{d} , {a}_{k , d} , {b}_{k , d} , V ) := m ( t , {a}_{k , d} , {b}_{k , d} , V ) {x}_{d , t} + ( 1 - m ( t , {a}_{k , d} , {b}_{k , d} , V ) ) {μ}_{d , t} \qquad ( 8 )$$

$$m ( t , {a}_{k , d} , {b}_{k , d} , V ) := {\tilde{v}}_{k , d} min ( σ ( t - {a}_{k , d} ) , 1 - σ ( t - {b}_{k , d} ) ) \qquad ( 9 )$$

$${\tilde{v}}_{k , d} = \frac{{v}_{k , d}^{2}}{{\sum }_{\tilde{k} = 1}^{K} {v}_{k , d}^{2}} \qquad ( 10 )$$

The expression (10) corresponds to processing of performing normalization in such a manner that the section weight v_{k, d} is a value of 0 or more and the sum of all the K sections SA is 1 in each of the variables d.

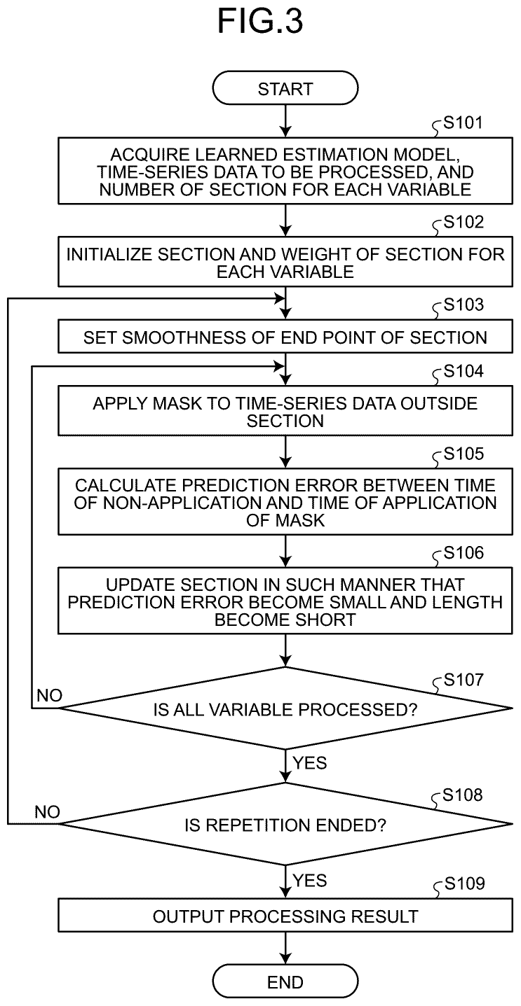

Next, a procedure of the estimation processing by the information processing device 100 of the first embodiment will be described with reference to FIG. 3. FIG. 3 is a flowchart illustrating an example of the estimation processing in the first embodiment.

The reception unit 101 acquires the learned estimation model f, the D-variate time-series data X to be processed, and the number K_{d} of the sections SA for each of the D variables d (Step S101). As described above, in the present embodiment, since the user designates the number of sections SA for each of the variables, a total of K₁+K₂+ . . . +K_{D} sections SA are obtained for all the variables.

Then, the estimation unit 120 initializes a section a_{k, d} to b_{k, d} inclusive, for each of the variables and each of the sections SA. Note that in a case where the section weight v_{k, d} of each of the sections SA is considered, the estimation unit 120 also initializes the section weight v_{k, d} of each of the sections SA (Step S102).

The method of initialization may be any method, and, for example, a method of setting a random value and a method of setting a predetermined value (fixed value or default value) can be applied. For example, a common fixed value may be set for the variables, or a different fixed value may be set for each of the variables. In addition, for the section SA, a section indicating the entire range of the time-series data X may be set as the initial value. Note that as described later, learning is performed in such a manner that the length of the section SA decreases in the present embodiment. Therefore, it is possible to control obtaining of the entire range of the time-series data X as the final section SA.

Thereafter, for each of the variables d (d=1, 2, . . . , and D), positions (a_{k, d}, b_{k, d}) of both end points of K_{d} sections SA are learned by repetition of the processing of Step S103 to Step S107.

First, the mask application unit 121 sets smoothness of both end points of the section SA (Step S103). For example, in a case where both end points are defined by utilization of the sigmoid function, the mask application unit 121 sets the smoothness by the temperature parameter of the sigmoid function (β in the above-described expression (5)). The value of the temperature parameter may be a fixed value, or may be adjusted in such a manner that the smoothness decreases as the repetition progresses.

The mask application unit 121 applies a mask to the time-series data in consideration of the section SA for an unprocessed variable d. For example, the mask application unit 121 applies the mask processing to the partial time-series data in the section SB other than the section SA in the time-series data X (Step S104). The time-series data to which the mask processing is applied is defined as Π(X).

For example, the mask application unit 121 hardly applies the mask processing within the section SA, whereas increases the application rate of the mask processing as deviation from the section SA becomes larger. The application rate of the mask processing can be interpreted to change with smoothness of the both end points. In one example, the application rate of the mask processing increases in accordance with the smoothness from the end point of the section SA toward the outside of the section SA, and the application rate decreases in accordance with the smoothness toward the inside of the section SA. Therefore, the smoothness of the both end points can also be interpreted to represent a degree of increase and decrease in the application rate. The mask application unit 121 may apply the mask processing in such a manner that the smoothness representing the degree of increase and decrease in the application rate becomes steeper as the repetition progresses.

In a case of considering the section weight V, the mask application unit 121 may execute the mask processing in such a manner that the application rate becomes larger as the section SA has the smaller section weight v_{k, d}.

The calculation unit 122 calculates a difference (prediction error) in the estimation result by the estimation model f between the time of non-application and the time of application of the mask processing (Step S105). For example, the calculation unit 122 inputs the time-series data X, to which the mask processing is not applied, to the estimation model f, and calculates f(X) obtained as an output. The calculation unit 122 inputs the time-series data Π(X) to which the mask processing is applied to the estimation model f, and calculates f(Π(X)) obtained as an output. The calculation unit 122 calculates a prediction error that is a difference between f(X) and f(Π(X)). In the above-described expression (1), the value of the error function L of the first term of the objective function corresponds to the prediction error.

The update unit 123 updates the designated K sections SA in such a manner as to minimize the objective function (Step S106). In a case of using the expression (1), the update unit 123 updates the sections SA in such a manner that the prediction error becomes small (first term) and the length becomes short (second term). In a case of considering the section weight v_{k, d} of each of the sections SA, the update unit 123 also updates the section weight v_{k, d} of each of the sections SA in such a manner as to reduce the prediction error for each of the sections SA, for example, by using the expression (6).

Note that the update of the sections SA for reduction of the prediction error and the update of the sections SA for reduction of the length may be executed simultaneously or at different timing. In the latter case, for example, the update unit 123 updates the left end point a_{k, d} and the right end point b_{k, d} in such a manner as to reduce the prediction error for each of the sections SA. Then, for each of the sections SA, the update unit 123 updates the left end point a_{k, d} and the right end point b_{k, d} in such a manner that the length of the section SA decreases. For example, the update unit 123 applies regularization of the Fused Lasso on the time-series data, and updates the left end point a_{k, d} and the right end point b_{k, d} by the gradient descent method or the like in such a manner that the regularization term becomes smaller.

The estimation unit 120 determines whether all the variables d are processed (Step S107). In a case where not all the variables d are processed (Step S107: No), the processing returns to Step S104, and the processing is repeated for a next unprocessed variable d. The next unprocessed variable d can be obtained by, for example, setting the initial value to d=1 and adding 1 to d (d=d+1).

In a case where all the variables d are processed (Step S107: Yes), the estimation unit 120 determines whether to end the repetition (Step S108). In one example, the estimation unit 120 determines to end the repetition when the number of times of the repetition by the gradient descent method reaches the designated number of times.

In a case where the repetition is not ended (Step S108: No), the estimation unit 120 returns to Step S103, returns all the variables d to the unprocessed state, and repeats the processing.

In a case of ending the repetition (Step S108: Yes), the output control unit 102 outputs a processing result of the repetition processing (Step S109), and ends the estimation processing. For example, the output control unit 102 displays, on the display unit 132, the K sections SA obtained by the repetitive update processing by the update unit 123.

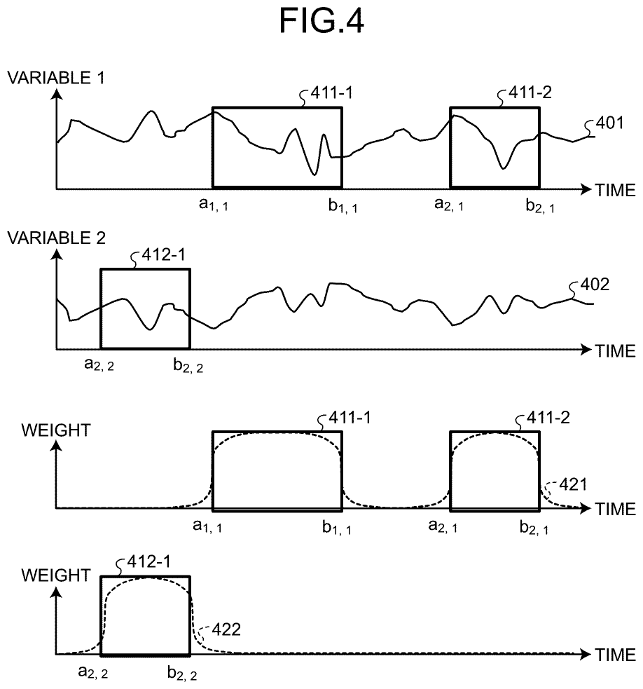

FIG. 4 is a view illustrating an example of a display screen that displays the processing result. Note that FIG. 4 is an example of the display screen of a case where time-series data in which the number D of variables is 2 (bivariate time-series data) is a target. In addition, an example in which 2 is designated as the number of sections SA for a variable 1, and 1 is designated as the number of sections SA for a variable 2 is illustrated in FIG. 4.

As illustrated in FIG. 4, the output control unit 102 displays the display screen including sections 411-1, 411-2, and 412-1 corresponding to the sections SA contributing to prediction in the time-series data X and information indicating both end points (left end point a_{k, d} and right end point b_{k, d}) obtained by learning.

A graph 401 corresponds to time-series data of the first variable 1. A graph 402 corresponds to time-series data of the second variable 2. A graph 421 represents weight of a section of the variable 1. A graph 422 represents weight of a section of the variable 2.

In such a manner, in a case where the section weight V of the sections SA is considered, the section weight V can also be visualized. On the basis of the visualized processing result, the user can confirm which section SA of the time-series data is a basis of the prediction by the estimation model f.

Next, examples of the mask processing will be described. The mask processing may be any kind of processing as long as being processing of replacing the time-series data in the section SB in such a manner that the estimation result does not change even in a case where the mask process is applied. The specific method of masking depends on context. In other words, any mask according with the context may be used. In the following, two examples of the mask corresponding to μ_{d} in the above-described expression (3) will be described.

### Mask Example 1

In this example, the estimation model is a model that estimates a class to which the input time-series data belongs among plural classes (such as a model that performs time-series classification). The mask processing in this example is processing of replacing the partial time-series data in the section SB with time-series data μ_{d} calculated on the basis of plural pieces of time-series data obtained in advance and corresponding to a class other than the estimated class. An average value of a given number of pieces of time-series data, which are similar to the time-series data X, in the time-series data of the class different from the class to be processed (estimated class) is calculated as the time-series data pa with which the replacement is performed.

### Mask Example 2

In this example, the estimation model is a model that estimates whether input time-series data is in a specific state (such as a model that performs unsupervised abnormal waveform detection). The specific state may be a normal state or an abnormal state. The mask processing in this example is processing of replacing the partial time-series data in the section SB with the time-series data pa calculated on the basis of plural pieces of time-series data that are obtained in advance and are not in the specific state. In a case of the unsupervised abnormal waveform detection, an average value of a given number of pieces of normal time-series data (time-series data that is not in the specific state) is calculated as the time-series data pa with which the replacement is performed.

The objective function is not limited to the function described above. In the following, a modification example of the objective function will be described. Note that a modification described in the following modification example can be similarly applied not only to the objective function of the first embodiment but also to an objective function of the second embodiment.

### Modification Example

In the modification example, an update unit 123 updates a section SA in such a manner as to minimize a regularization term included in an objective function within a range of a limit of a value of a difference (prediction error). In addition, the update unit 123 updates the section SA in such a manner as to minimize the difference (prediction error) included in the objective function within a range of a limit of a length of the section SA.

An expression (11) described below is an example of the objective function that can be used in the present modification example. As compared with the above-described expression (1), the third term and the fourth term are added in the expression (11). The third term corresponds to a term for consideration of the limit of the value of the difference. The fourth term corresponds to a term for consideration of the limit of the length of the section SA.

$${minimize}_{A ∈ {ℝ}^{K \times D} , B ∈ {ℝ}^{K \times D}} ℒ ( f ( X ) , ( f ∘ \prod ) ( X ) ) + λ {\sum }_{d = 1}^{D} {\sum }_{k = 1}^{K} ( {b}_{k , d} - {a}_{k , d} ) + v max ( ℒ ( f ( X ) , ( f ∘ \prod ) ( X ) ) - P , 0 ) + μmax ( {\sum }_{d = 1}^{D} {\sum }_{k = 1}^{K} ( {b}_{k , d} - {a}_{k , d} ) - Q , 0 ) \qquad ( 11 )$$

In the expression (11), v and u are newly introduced in addition to A as non-negative hyperparameters. P corresponds to a maximum value of an allowable prediction error. Q corresponds to a maximum value (maximum length) of the sum of plural sections SA. The maximum value Q can also be interpreted to correspond to a ratio of the sections SA to a time-series data length. P and Q are set by a user, for example.

For example, when the prediction error does not exceed the maximum value P, the third term becomes 0 and becomes invalid. For example, when the sum of the sections SA does not exceed the maximum value Q, the fourth term becomes 0 and becomes invalid.

Note that the update unit 123 may be configured to consider either the limit of the value of the difference (prediction error) or the limit of the length of the sections SA. Such a configuration can be implemented, for example, by setting of any one of the hyperparameters v and μ to 0.

The expression (11) is an example in which the limit of the sum of the plural sections SA is considered. The limit of the length may be considered for each of the plural sections SA. An expression (12) below is an example of the objective function that can be used in this case. In the expression (12), the fourth term is changed as compared with the expression (11).

$${minimize}_{A ∈ {ℝ}^{K \times D} , B ∈ {ℝ}^{K \times D}} ℒ ( f ( X ) , ( f ∘ \prod ) ( X ) ) + λ {\sum }_{d = 1}^{D} {\sum }_{k = 1}^{K} ( {b}_{k , d} - {a}_{k , d} ) + v max ( ℒ ( f ( X ) , ( f ∘ \prod ) ( X ) ) - P , 0 ) + μ {\sum }_{d = 1}^{D} {\sum }_{k = 1}^{K} max ( ( {b}_{k , d} - {a}_{k , d} ) - {Q}_{d} , 0 ) \qquad ( 12 )$$

In this example, the user designates the maximum value Q_{d} (d=1, 2, . . . , and D) of the length of the sections SA for each of the variables d. The fourth term of the expression (12) becomes 0 and invalid when the length of each of the sections SA does not exceed the corresponding maximum value Q_{d}. Note that, when it is not necessary to individually designate the maximum length of the sections SA in each of the variables, a maximum length common to all the variables may be designated, or a maximum length common to a part of the variables may be designated.

As described above, in the first embodiment, the number of sections SA to be output as the basis of the analysis can be designated, and the designated number of sections SA are updated in such a manner as to reduce the prediction error. The sections SA may be updated with the maximum length being limited. Since the number of sections SA is a parameter that is easy for the user to understand, the basis expected by the user can be more appropriately output. It is possible to more appropriately obtain a portion that serves as a basis of the analysis of the time-series data.

### Second Embodiment

Next, the second embodiment corresponding to (M2) described above will be described. An information processing device of the second embodiment learns sections SA of the number commonly designated for D variables. At this time, weight for each of the variables is also learned. The weight of each of the variables can also be interpreted as an index representing importance of the variable or representing whether the variable is valid. Therefore, in the second embodiment, it is possible to specify an important variable by considering the weight of the variables.

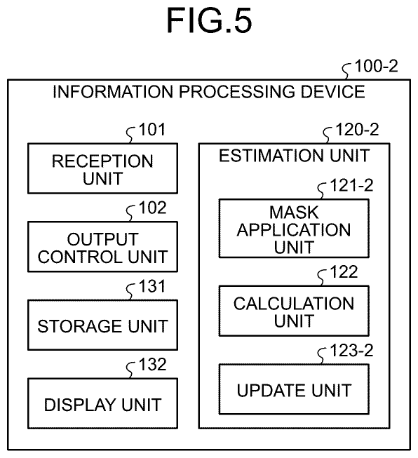

FIG. 5 is a block diagram illustrating an example of a configuration of an information processing device 100-2 of the second embodiment. As illustrated in FIG. 5, the information processing device 100-2 includes a reception unit 101, an estimation unit 120-2, an output control unit 102, a storage unit 131, and a display unit 132. The estimation unit 120-2 includes a mask application unit 121-2, a calculation unit 122, and an update unit 123-2.

In the second embodiment, functions of the mask application unit 121-2 and the update unit 123-2 in the estimation unit 120-2 are different from those of the first embodiment. The other configurations and functions are similar to those in FIG. 2 that is a block diagram of the information processing device 100 of the first embodiment. Therefore, the same sign is assigned and description is omitted herein.

The mask application unit 121-2 is different from the mask application unit 121 of the first embodiment in a point that mask processing is applied in consideration of weight of the variables. For example, the mask application unit 121-2 applies the mask processing in such a manner as to increase an application rate for a variable with small weight and reduce the application rate for a variable with large weight. As a result, it is possible to specify the section SA that contributes to prediction by focusing on the variable having the large weight.

The update unit 123-2 updates the sections SA in such a manner as to optimize an objective function further including the term related to the weight of the variables.

The objective variable of the present embodiment includes, for example, a term in which the application rate of the mask processing changes with D pieces of weight w (second weight) respectively corresponding to the D variables. Hereinafter, the weight of the variables is referred to as variable weight w. The following expression (13) is an example of the objective function that can be used in the present embodiment.

$${minimize}_{a ∈ {ℝ}^{K \times D} , b ∈ {ℝ}^{K \times D} , W ∈ {ℝ}^{K \times D}} ℒ ( f ( X ) , ( f ∘ \prod ) ( X ) ) + λ {\sum }_{k = 1}^{K} ( {b}_{k} - {a}_{k} ) + α {\sum }_{k = 1}^{K} ( 1 - {max}_{d = 1 , 2 , … , D} {\tilde{ω}}_{k , d} ) \qquad ( 13 )$$

The expression (13) is different from the expression (1) of the first embodiment in a point that the third term, which is a term related to a maximum value of the variable weight w, is added, and that the variable weight w is also updated to minimize a prediction error (WϵR^{K×D} in a lower part of minimize).

The third term corresponds to a term of updating the sections SA and the variable weight w in such a manner that the variable weight w having the maximum value approaches a prescribed value (1 in the example of the expression (13)) and the variable weight w not having the maximum value approaches 0. α is a non-negative hyperparameter. Note that the objective function may be configured not to include the third term.

Π(X) corresponding to the mask processing of the present embodiment is expressed by the following expression (14). The right side of the expression (14) is expressed by the following expression (15). In addition, m( ) in the expression (15) is expressed by the following expression (16).

$${[ \prod ( X ) ]}_{d , t} := π ( d , t , {x}_{d} , {μ}_{d} , {a}_{k} , {b}_{k} , {w}_{k} ) \qquad ( 14 )$$

$$π ( d , t , {x}_{d} , {μ}_{d} , {a}_{k} , {b}_{k} , {w}_{k} ) := m ( d , t , {a}_{k ,} {b}_{k} , {w}_{k} ) {x}_{d , t} + ( 1 - m ( d , t , {a}_{k ,} {b}_{k} , {w}_{k} ) ) {μ}_{d , t} \qquad ( 15 )$$

$$m ( d , t , {a}_{k ,} {b}_{k} , {w}_{k} ) := {\tilde{ω}}_{k , d} min ( σ ( t - {a}_{k} ) , 1 - σ ( t - {b}_{k} ) ) \qquad ( 16 )$$

w_{k, d}˜ (variable with a tilde symbol “˜” above w_{k, d}) in the expression (16) is expressed by the following expression (17).

$${\tilde{ω}}_{k , d} = \frac{{ω}_{k , d}^{2}}{{\sum }_{\tilde{d} = 1}^{D} {ω}_{k , d}^{2}} \qquad ( 17 )$$

The expression (17) corresponds to processing of performing normalization in such a manner that each piece of the variable weight w becomes a value of 0 or more and the sum of all the D variables becomes 1 for each of k=1, 2, . . . , and K.

The expression (16) is different from the expression (4) of the first embodiment in a point that, a multiplication by a value w˜ obtained by the normalization of the variable weight w is performed. As a result, a function in which the application rate of the mask processing changes with the variable weight w (mask application unit 121-2) is implemented.

Similarly to the first embodiment, the objective function may include a term in which the application rate of the mask processing changes with the section weight. In the second embodiment, the sections SA are common to the D variables. Therefore, the section weight is represented by a K-dimensional continuous value vector corresponding to the K sections. Hereinafter, the section weight represented by the continuous value vector is represented as section weight v. The following expression (18) expresses an example of the objective function including a term related to the section weight v.

$${minimize}_{a ∈ {ℝ}^{K} , b ∈ {ℝ}^{K} , W ∈ {ℝ}^{K \times D} , v ∈ {ℝ}^{K}} ℒ ( f ( X ) , ( f ∘ \prod ) ( X ) ) + λ {\sum }_{k = 1}^{K} ( {b}_{k} - {a}_{k} ) + α {\sum }_{k = 1}^{K} ( 1 - {max}_{d = 1 , 2 , … , D} {\tilde{ω}}_{k , d} ) \qquad ( 18 )$$

The following expression (19) expresses an example of Π(X) used in the expression (18). The right side of the expression (19) is expressed by the following expression (20). In addition, m ( ) in the expression (20) is expressed by the following expression (21). v˜ in the expression (21) is expressed by the following expression (22).

$${[ \prod ( X ) ]}_{d , t} := π ( d , t , {x}_{d} , {μ}_{d} , {a}_{k} , {b}_{k} , {w}_{k} , v ) \qquad ( 19 )$$

$$π ( d , t , {x}_{d} , {μ}_{d} , {a}_{k} , {b}_{k} , {w}_{k} , v ) := m ( d , t , {a}_{k ,} {b}_{k} , {w}_{k} , v ) {x}_{d , t} + ( 1 - m ( d , t , {a}_{k ,} {b}_{k} , {w}_{k} , v ) ) {μ}_{d , t} \qquad ( 20 )$$

$$m ( d , t , {a}_{k ,} {b}_{k} , {w}_{k} , v ) := {\tilde{ω}}_{k , d} {\tilde{v}}_{k} min ( σ ( t - {a}_{k} ) , 1 - σ ( t - {b}_{k} ) ) \qquad ( 21 )$$

$${\tilde{v}}_{k} = \frac{{v}_{k}^{2}}{{\sum }_{\tilde{k} = 1}^{K} {v}_{k}^{2}} \qquad ( 22 )$$

By using the above-described objective function, the update unit 123-2 minimizes the difference (prediction error) and updates the sections SA and the variable weight w in such a manner that the variable weight w having the maximum value approaches the prescribed value (such as 1) and the variable weight w not having the maximum value approaches 0.

The update unit 123-2 may change a with progress of the repeated update processing. Changing a corresponds to adjusting whether to prioritize the minimization of the difference (first term) or to prioritize the processing in which the variable weight having the maximum value approaches the prescribed value and the variable weight not having the maximum value approaches 0 (third term). For example, at an early stage of the update processing (for example, the number of times of repetition is equal to or smaller than a threshold), the update unit 123-2 gives priority to the minimization of the difference (prediction error) by decreasing α. Then, at an end of the update processing (for example, the number of times of repetition exceeds the threshold), the update unit 123-2 gives priority to the processing of the third term, in which the variable weight having the maximum value approaches the prescribed value, by increasing α.

Next, various kinds of data used in estimation processing by the information processing device 100-2 of the second embodiment will be described. The estimation processing of the present embodiment is processing of estimating (learning) to which variable the section SA corresponds together with a portion serving as a basis of an estimation result (positions of both end points of the section SA) for the estimation result of the time-series data X by the learned estimation model f.

In the present embodiment, the number K common to all the variables is designated as the number of sections SA. Therefore, in the present embodiment, the positions of the left end point a and the right end point b of the sections SA are respectively represented by the K-dimensional continuous value vectors.

For each of the sections SA, the variable weight w of each of the variables is represented by a continuous value matrix of K×D. Note that in a case where the section weight v of each of the sections SA is considered, the section weight v is expressed as a K-dimensional continuous value vector.

A position of the left end point, a position of the right end point, variable weight w for the variable d, and section weight v of the k-th section SA are respectively described as aₖ, bₖ, w_{k, d}, and vₖ. Note that the variable weight w and the section weight v are determined in such a manner as to satisfy the following conditions (C2) and (C3), respectively.

$$With k = 1 , 2 , … , and K and d = 1 , 2 , … , \\ and D , {w}_{k , d} \geq 0 and {w}_{k , 1} + {w}_{k , 2} + … + {w}_{k , D} = 1 \qquad ( C2 )$$

$$With k = 1 , 2 , … , and K , {v}_{k} \geq 0 and {v}_{1} + {v}_{2} + … + {v}_{k} = 1 \qquad ( C3 )$$

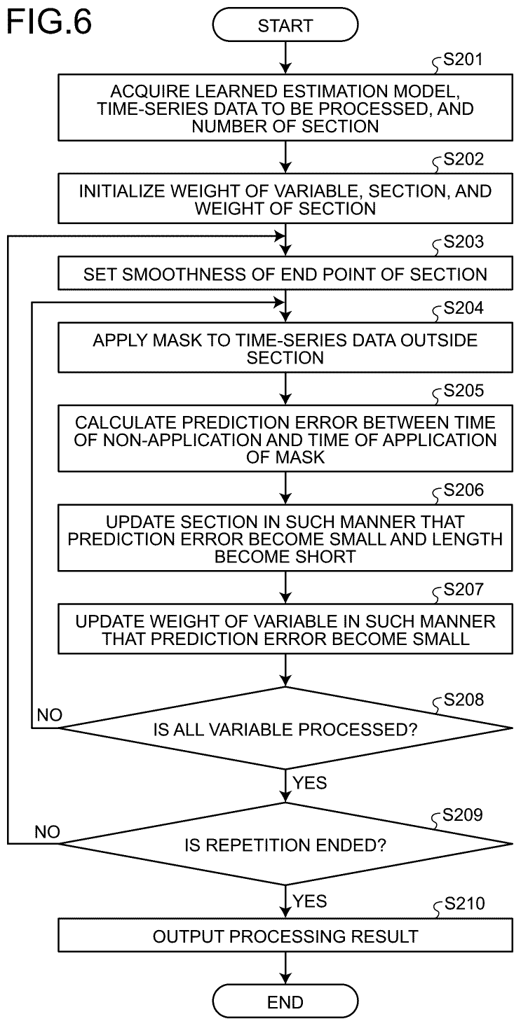

Next, the estimation processing by the information processing device 100-2 of the second embodiment will be described with reference to FIG. 6. FIG. 6 is a flowchart illustrating an example of the estimation processing in the second embodiment.

In the present embodiment, the reception unit 101 acquires the learned estimation model f, the D-variate time-series data X to be processed, and the number K of sections SA which number is common to the variables (Step S201).

The estimation unit 120-2 initializes the variable weight w_{k, d} in addition to the section SA (section aₖ to bₖ inclusive). In a case of considering the section weight v, the estimation unit 120-2 also initializes the section weight vₖ (Step S202).

Step S203 is similar to Step S103 of the flowchart of the estimation processing of the first embodiment (FIG. 3).

The mask application unit 121-2 applies the mask processing to partial time-series data in a section SB other than the section SA in the time-series data X (Step S204). In the present embodiment, the mask application unit 121-2 applies the mask processing in such a manner that the application rate changes with the variable weight w. For example, the mask application unit 121-2 increases the application rate for a variable with the small variable weight w and decreases the application rate for a variable with the large variable weight w. This makes it possible to specify the section SA that contributes to prediction by focusing on the variable having the large variable weight.

Step S205 and Step S206 are similar to Step S105 and Step S106 of the flowchart of the estimation processing of the first embodiment (FIG. 3).

In the present embodiment, the update unit 123-2 updates the variable weight w_{k, 1}, w_{k, 2}, . . . , and w_{k, D} in such a manner that the prediction error becomes small (Step S207). As expressed in the third term of the expression (13), the update unit 123-2 may update each of the sections SA in such a manner that the maximum value of the variable weight w_{k, d} approaches a prescribed value (such as 1) and the variable weight w_{k, d′} other than the maximum value approaches 0. As a result, the section SA to be finally output can be made to correspond to one specific variable.

Note that the processing of updating the sections SA in Step S206 and the processing of updating the variable weight w in Step S207 may be executed simultaneously or at different timing.

Step S208 to Step S210 are similar to Step S107 to Step S109 in the flowchart of the estimation processing of the first embodiment (FIG. 3), so that the description thereof will be omitted.

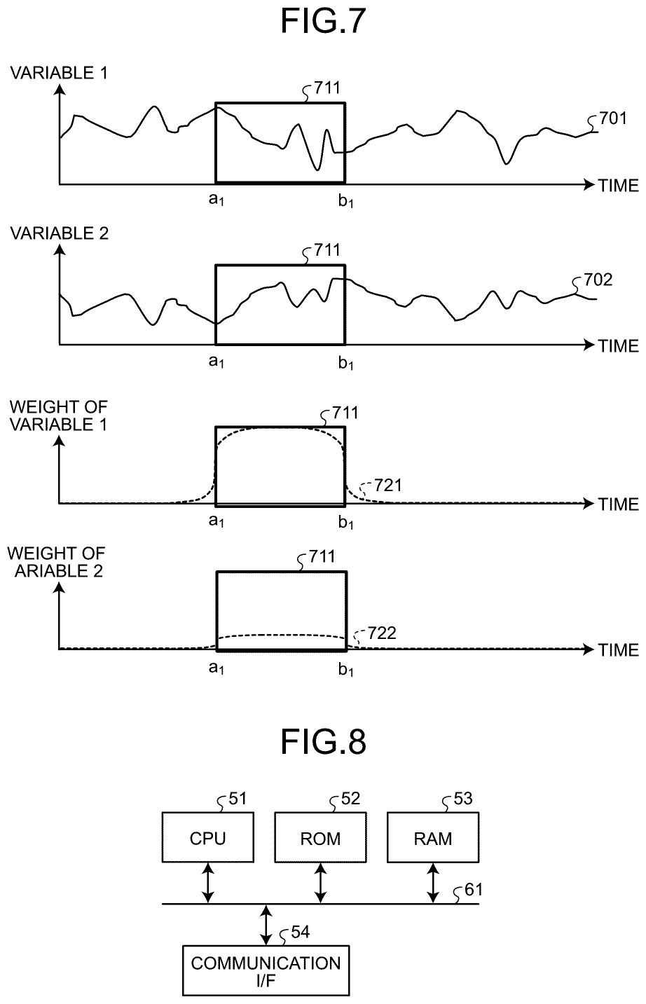

FIG. 7 is a view illustrating an example of a display screen of the present embodiment. Note that FIG. 7 is an example of the display screen of a case where time-series data in which the number D of variables is 2 (bivariate time-series data) is a target. In addition, an example in which 1 is designated as the number K of sections SA which number is common to the variables is illustrated in FIG. 7.

As illustrated in FIG. 7, the output control unit 102 displays the display screen including a section 711 corresponding to the section SA contributing to prediction in the time-series data X and information indicating both end points (left end point aₖ and right end point bₖ) obtained by learning.

A graph 701 corresponds to time-series data of a first variable 1. A graph 702 corresponds to time-series data of a second variable 2. A graph 721 represents variable weight w of the variable 1. A graph 722 represents variable weight w of the variable 2. An example in which the variable weight of the variable 1 is larger than that of the variable 2 is illustrated in FIG. 7. Note that in a case where the section weight v of each of the sections SA is considered, the section weight v may be further visualized, for example, similarly to the graph 22 of FIG. 1.

On the basis of the visualized processing result, the user can confirm which section SA of which variable of the time-series data is a basis of the prediction by the estimation model f.

As described above, in the second embodiment, a value common to the plural variables can be designated as the number of sections SA, and the designated number of sections SA are updated in such a manner that the prediction error is reduced. In addition, the weight (variable weight) of each of the plural variables is updated in such a manner that the prediction error is reduced. This makes it possible to specify an important variable.

As described above, according to the first to second embodiments, it is possible to more appropriately obtain a portion serving as a basis of analysis of the time-series data.

Next, a hardware configuration of the information processing device of the first or second embodiment will be described with reference to FIG. 8. FIG. 8 is a view for describing a hardware configuration example of the information processing device of the first or second embodiment.

The information processing device of the first or second embodiment includes a control device such as a CPU 51, a storage device such as a read only memory (ROM) 52 or a RAM 53, a communication I/F 54 that is connected to a network and performs communication, and a bus 61 that connects the units.

A computer program executed by the information processing device of the first or second embodiment is previously installed in the ROM 52 or the like and provided.

A computer program executed by the information processing device of the first or second embodiment may be recorded, as a file in an installable format or an executable format, into a computer-readable recording medium such as a compact disk read only memory (CD-ROM), a flexible disk (FD), a compact disk recordable (CD-R), or a digital versatile disk (DVD), and provided as a computer program product.

Moreover, the program executed in the information processing device of the first or second embodiment may be stored on a computer connected to a network such as the Internet and may be provided by being downloaded via the network. In addition, the program executed in the information processing device of the first or second embodiment may be provided or distributed via the network such as the Internet.

The program executed in the information processing device of the first or second embodiment may cause a computer to function as each unit of the information processing device described above. In this computer, the CPU 51 can read a program from a computer-readable storage medium onto a main storage device and perform execution thereof.

Configuration examples of the embodiments will be described in the following.

### Configuration Example 1

An information processing device comprising:
one or more hardware processors configured to execute update processing on a designated number of first sections on the basis of a first estimation result and a second estimation result, the first estimation result being obtained by inputting first time-series data to an estimation model, the second estimation result being obtained by inputting second time-series data to the estimation model, the second time-series data being obtained by applying mask processing to partial time-series data of a second section in the first time-series data, the second section being other than the designated number of the first sections.

### Configuration Example 2

The information processing device according to the configuration example 1, wherein the one or more hardware processors are configured to execute the update processing on the basis of an objective function including a difference between the first estimation result and the second estimation result.

### Configuration Example 3

The information processing device according to the configuration example 2, wherein the one or more hardware processors are configured to execute the update processing in such a manner as to optimize the objective function.

### Configuration Example 4

The information processing device according to the configuration example 1, wherein the one or more hardware processors are configured to
apply the mask processing to the partial time-series data of the second section,
calculate a difference between the first estimation result and the second estimation result, and
execute the update processing on the basis of an objective function including the difference between the first/second estimation results.

### Configuration Example 5

The information processing device according to the configuration example 4, wherein the one or more hardware processors are configured to apply the mask processing in such a manner that an application rate of the mask processing increases from an end point of the first section toward an outside of the first section and the application rate decreases toward an inside of the first section.

### Configuration Example 6

The information processing device according to the configuration example 5, wherein the one or more hardware processors are configured to
repeatedly execute the update processing, and
apply the mask processing in such a manner that smoothness representing a degree of the increase and the decrease of the application rate becomes steeper as the repetition of the update processing proceeds.

### Configuration Example 7

The information processing device according to any one of the configuration examples 1 to 6, wherein the first section is defined by positions of two end points on the first time-series data, or defined by one end point and a length of the first section.

### Configuration Example 8

The information processing device according to any one of the configuration examples 1 to 7, wherein the one or more hardware processors are configured to update the first sections on the basis of an objective function including
a difference between the first estimation result and the second estimation result, and
a regularization term whose value becoming smaller as a length of the first sections becomes shorter.

### Configuration Example 9

The information processing device according to the configuration example 8, wherein the one or more hardware processors are configured to update the first sections in such a manner as to optimize the regularization term included in the objective function within a range of a limit of a value of the difference between the first/second estimation results.

### Configuration Example 10

The information processing device according to any one of the configuration examples 1 to 9, wherein the one or more hardware processors are configured to update the first sections in such a manner as to minimize a difference between the first estimation result and the second estimation result within a range of a limit of the length of the first sections.

### Configuration Example 11

The information processing device according to any one of the configuration examples 1 to 10, wherein
the one or more hardware processors are configured to update the first sections and pieces of first weight on the basis of an objective function, the pieces of first weight respectively corresponding to the designated number of the first sections, and
the objective function includes
   a difference between the first estimation result and the second estimation result, and
   a term in which an application rate of the mask processing changes with the pieces of first weight.

### Configuration Example 12

The information processing device according to any one of the configuration examples 1 to 11, wherein
the first time-series data is D-variate time-series data including D variables, where D is an integer of 1 or more, and
the designated number is designated for each of the D variables.

### Configuration Example 13

The information processing device according to any one of the configuration examples 1 to 11, wherein
the first time-series data is D-variate time-series data including D variables, where D is an integer of 1 or more, and
a value being common to the D variables is designated as the designated number.

### Configuration Example 14

The information processing device according to the configuration example 13, wherein
the one or more hardware processors are configured to update the first sections and D pieces of second weight respectively corresponding to the D variables on the basis of an objective function,
the objective function includes
   a difference between the first estimation result and the second estimation result, and
   a term in which an application rate of the mask processing changes with the D pieces of second weight, and
the update of the first sections and the D pieces of second weight is performed in such a manner that
   the difference between the first/second estimation results is minimized, and
   the second weight having a maximum value approaches a prescribed value and the second weight not having the maximum value approaches zero.

### Configuration Example 15

The information processing device according to the configuration example 14, wherein the one or more hardware processors are configured to
repeatedly execute the update processing, and
adjust, in accordance with progress of the update processing, whether to prioritize processing in which the difference between the first/second estimation results is minimized or to prioritize processing in which the second weight having the maximum value approaching the prescribed value and the second weight not having the maximum value approaching zero.

### Configuration Example 16

The information processing device according to any one of the configuration examples 1 to 15, wherein
the estimation model is a model to estimate whether input time-series data is in a specific state, and
the mask processing is processing to replace the partial time-series data of the second section with time-series data calculated on the basis of pieces of time-series data being obtained in advance and not in the specific state.

### Configuration Example 17

The information processing device according to any one of the configuration examples 1 to 15, wherein
the estimation model is a model to estimate one of classes to which input time-series data belongs, and
the mask processing is processing to replace the partial time-series data of the second section with time-series data calculated on the basis of pieces of time-series data being obtained in advance and belonging to a class other than a class corresponding to the first estimation result.

### Configuration Example 18

18. The information processing device according to any one of the configuration examples 1 to 16, wherein the one or more hardware processors are configured to control output of the designated number of first sections being a result of the update processing.

### Configuration Example 19

The information processing device according to any one of the configuration examples 1 to 18, wherein the one or more hardware processors are configured to execute the update processing on the basis of the first estimation result and the second estimation result.

### Configuration Example 20

An information processing method implemented by a computer, the method comprising:
executing update processing on a designated number of first sections on the basis of a first estimation result and a second estimation result, the first estimation result being obtained by inputting first time-series data to an estimation model, the second estimation result being obtained by inputting second time-series data to the estimation model, the second time-series data being obtained by applying mask processing to partial time-series data of a second section in the first time-series data, the second section being other than the designated number of the first sections.

### Configuration Example 21

A computer program product comprising a non-transitory computer-readable recording medium on which a program executable by a computer is recorded, the program instructing the computer to:
execute update processing on a designated number of first sections on the basis of a first estimation result and a second estimation result, the first estimation result being obtained by inputting first time-series data to an estimation model, the second estimation result being obtained by inputting second time-series data to the estimation model, the second time-series data being obtained by applying mask processing to partial time-series data of a second section in the first time-series data, the second section being other than the designated number of the first sections.

While some embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to:
execute update processing on a designated number of first sections on a basis of a first estimation result and a second estimation result,
wherein the first estimation result is obtained by inputting a first time-series data to an estimation model,
wherein the second estimation result is obtained by inputting a second time-series data to the estimation model,
wherein the second time-series data is obtained by applying mask processing to a partial time-series data of a second section in the first time-series data, and
wherein the second section being other than the designated number of the first sections.

2. The information processing device according to claim 1, wherein the one or more hardware processors are configured to:
execute the update processing based on an objective function including a difference between the first estimation result and the second estimation result.

3. The information processing device according to claim 2, wherein the one or more hardware processors are configured to:
execute the update processing in such a manner as to optimize the objective function.

4. The information processing device according to claim 1, wherein the one or more hardware processors are configured to:
apply the mask processing to the partial time-series data of the second section;
calculate a difference between the first estimation result and the second estimation result; and
execute the update processing based on an objective function including the difference between the first estimation results and the second estimation results.

5. The information processing device according to claim 4, wherein the one or more hardware processors are configured to:
apply the mask processing in such a manner that an application rate of the mask processing increases from an end point of the first section towards an outside of the first section, and the application rate decreases towards an inside of the first section.

6. The information processing device according to claim 5, wherein the one or more hardware processors are configured to:
execute the update processing repeatedly, and
apply the mask processing in such a manner that smoothness representing a degree of the increase and the decrease of the application rate becomes steeper as the one or more hardware processors execute the update processing repeatedly.

7. The information processing device according to claim 1, wherein the first section is defined by a position of a first end point and a second end point on the first time-series data, or wherein the first section is defined by one end point and a length of the first section.

8. The information processing device according to claim 1, wherein the one or more hardware processors are configured to:
update the first sections on the basis of an objective function including,
a difference between the first estimation result and the second estimation result, and
a regularization term whose value reduces as a length of the first sections becomes shorter.

9. The information processing device according to claim 8, wherein the one or more hardware processors are configured to:
update the first sections in such a manner as to optimize the regularization term included in the objective function within a range of a limit of a value, wherein the value is the difference between the first estimation results and the second estimation results.

10. The information processing device according to claim 1, wherein the one or more hardware processors are configured to:
update the first sections in such a manner as to minimize a difference between the first estimation result and the second estimation result within a range of a limit of a length of the first sections.

11. The information processing device according to claim 1, wherein
the one or more hardware processors are configured to:
update the first sections and pieces of a first weight based on an objective function, the pieces of the first weight respectively corresponding to the designated number of the first sections, and
the objective function comprises:
a difference between the first estimation result and the second estimation result, and
a term in which an application rate of the mask processing changes with the pieces of first weight.

12. The information processing device according to claim 1, wherein
the first time-series data is D-variate time-series data including D variables, where D is an integer greater than or equal to one, and
the designated number is assigned for each of the D variables.

13. The information processing device according to claim 1, wherein
The first time-series data is D-variate time-series data including D variables, where D is an integer greater than or equal to one, and
a value being common to the D variables is assigned as the designated number.

14. The information processing device according to claim 13, wherein
the one or more hardware processors are configured to:
update the first sections and D pieces of second weight respectively corresponding to the D variables based on an objective function;
the objective function comprises:
a difference between the first estimation result and the second estimation result,
a term in which an application rate of the mask processing changes with the D pieces of second weight,
wherein the update of the first sections and the D pieces of second weight is performed in such a manner that the difference between the first estimation results and the second estimation results is minimized, and
wherein the second weight having a maximum value approaches a prescribed value and the second weight not having the maximum value approaches zero.

15. The information processing device according to claim 14, wherein the one or more hardware processors are configured to:
repeatedly execute the update processing, and
adjust, in accordance with progress of the update processing, whether to prioritize processing in which the difference between the first estimation results and the second estimation results is minimized or to prioritize processing in which the second weight having the maximum value approaching the prescribed value and the second weight not having the maximum value approaching zero.

16. The information processing device according to claim 1, wherein
the estimation model is a model to estimate whether input time-series data is in a specific state, and
wherein the mask processing is to replace the partial time-series data of the second section with time-series data calculated on the basis of pieces of time-series data being obtained in advance and not in the specific state.

17. The information processing device according to claim 1, wherein
the estimation model is a model to estimate one of classes to which input time-series data belongs, and
wherein the mask processing is to replace the partial time-series data of the second section with time-series data calculated on the basis of pieces of time-series data being obtained in advance and belonging to a class other than a class corresponding to the first estimation result.

18. The information processing device according to claim 1, wherein the one or more hardware processors are configured to:
control output of the designated number of first sections as a result of the update processing.

19. The information processing device according to claim 1, wherein the one or more hardware processors are configured to:
execute the update processing on the basis of the first estimation result and the second estimation result.

20. An information processing method implemented by a computer, the method comprising:
executing update processing on a designated number of first sections on a basis of a first estimation result and a second estimation result, wherein the first estimation result is obtained by inputting first time-series data to an estimation model, wherein the second estimation result is obtained by inputting second time-series data to the estimation model, wherein the second time-series data is obtained by applying mask processing to partial time-series data of a second section in the first time-series data, and the second section being other than the designated number of the first sections.

21. A computer program product comprising a non-transitory computer-readable recording medium on which a program executable by a computer is recorded, the program instructing the computer to:
execute update processing on a designated number of first sections on a basis of a first estimation result and a second estimation result, wherein the first estimation result is obtained by inputting first time-series data to an estimation model, wherein the second estimation result is obtained by inputting second time-series data to the estimation model, wherein the second time-series data is obtained by applying mask processing to partial time-series data of a second section in the first time-series data, and the second section being other than the designated number of the first sections.
